(19) United States
(12) Patent Application Publication
(10) Pub. No.: US 2019/0102734 A1
(43) Pub. Date: Apr. 4, 2019

(54) QUALITY CONTROL SERVER

(71) Applicant: YOKOGAWA ELECTRIC CORPORATION, Tokyo (JP)

(72) Inventors: Hiromi KAWAMUKAI, Tokyo (JP); Daisuke IKEGAMI, Tokyo (JP)

(73) Assignee: YOKOGAWA ELECTRIC CORPORATION, Tokyo (JP)

(21) Appl. No.: 16/135,233

(22) Filed: Sep. 19, 2018

(30) Foreign Application Priority Data
Sep. 29, 2017 (JP) 2017-190154

(51) Int. Cl. G06Q 10/08; G06Q 10/06

(52) U.S. Cl. CPC G06Q 10/0833; G06Q 10/0832; G06Q 10/06395

(57) ABSTRACT

A quality control server includes a data controller and a quality information provision unit. The data controller receives measurement data, acquired by a sensor attached to a product, through sensor communication devices installed at installation locations along a distribution route of the product, each sensor communication device being associated with information indicating a responsible party for the installation location, and records the measurement data. The quality information provision unit associates received measurement data from the plurality of predetermined installation locations with the information indicating the responsible party for the installation location on the basis the received measurement data, location information indicating locations where the sensor communication devices are installed, and the distribution route. The quality information provision unit also associates the measurement data with the location information and displays the measurement data and the location information on a terminal connected over a network.

### CROSS-REFERENCE TO RELATED APPLICATION

The present application claims priority to and the benefit of Japanese Patent Application No. 2017-190154 filed Sep. 29, 2017, the entire contents of which are incorporated herein by reference.

### TECHNICAL FIELD

The present disclosure relates to quality control of products in the logistics industry.

### BACKGROUND

Quality control of products is important in the logistics industry, where products are delivered from a sender to a consignee. In particular, an unsuitable temperature environment or the like has a great impact on the quality of products in the case of distribution of food products, medical products, or the like. Therefore, merchants involved in the distribution of food products, medical products, or the like have attempted to maintain the quality of products by, for example, recording the temperature history with an independently developed control system.

A variety of merchants, such as senders, carriers, and warehousers, are involved along the distribution route, and each merchant separately controls the temperature as necessary. This makes it difficult to record and trace the overall temperature history. To address this issue, patent literature (PTL) 1 and 2, for example, propose individually identifying products using a tag, barcode, or the like and recording the temperature during the distribution process on a server in association with the products, thereby integrally controlling the temperature history of each product. It has also been proposed to judge whether products pass or fail in terms of quality and to provide information to the consignee or the like on the basis of the temperature hi story.

### CITATION LIST

### Patent Literature

PTL 1: JP2017057043A

PTL 2: JP2005154045A

### SUMMARY

The overall temperature history of a distribution route can be learned by integral control of the temperature history of products on a server. The above proposals, however, focus on techniques for controlling the temperature history during transportation and storage, with much less importance being given to the users of the quality control information, such as the sender or the consignee.

For example, those using the quality control information are basically allowed to view the change in temperature over time, with no consideration given to information and countermeasures important for the users of the quality control information, such as the party responsible for quality deviation and countermeasures to take upon quality deviation. Hence, the above proposals may not be sufficiently convenient for the users of quality control information. This problem occurs not only with temperature but also with the control of environmental data related to the quality of products, such as humidity, lighting intensity, acceleration, and inclination.

It would therefore be helpful to make quality control information more convenient for users during quality control of products in the logistics industry.

A quality control server according to an aspect of the present disclosure includes a data controller and a quality information provision unit. The data controller is configured to receive measurement data acquired by a sensor attached to a product and to record the measurement data, the measurement data being received through a plurality of sensor communication devices installed at a plurality of predetermined installation locations along a distribution route of the product, each sensor communication device being associated with information indicating a responsible party for the predetermined installation location of the sensor communication device. The quality information provision unit is configured to associate a plurality of received measurement data from the plurality of predetermined installation locations with the information indicating the responsible party for the predetermined installation location on the basis of the plurality of received measurement data, location information indicating locations where the plurality of sensor communication devices are installed, and the distribution route, associate the measurement data with the location information, and display the measurement data and the location information on a terminal connected over a network. Displaying the measurement data and location information in association with each other on a terminal in this way allows the user of the terminal to confirm the measurement data and the location information by looking at the display. This can improve convenience for the user of the quality control information.

In another aspect of the present disclosure, the sensor may include a setting processor configured to perform a setting related to a threshold of the measurement data, and the data controller may be configured to alert a predetermined recipient when information indicating deviation from the threshold is included in the received measurement data. Issuing an alert in this way makes it easier for the user to learn that the measurement data has deviated from the threshold. This can improve convenience for the user of the quality control information.

In another aspect of the present disclosure, the data controller may be configured to issue an inquiry related to a countermeasure to be taken to a predetermined party charged with prescribing countermeasures when the information indicating deviation from the threshold is included in the received measurement data, and the data controller may be configured to notify the responsible party, associated with the sensor communication device that transmitted the information indicating deviation from the threshold, of an instruction based on a response to the inquiry. Notifying the responsible party of an instruction based on the response in this way allows the responsible party to take a countermeasure in accordance with the instruction. This can improve convenience for the user of the quality control information.

In another aspect of the present disclosure, the quality information provision unit may be configured to display an indication of whether the information indicating deviation from the threshold exists for the product on the terminal connected over the network, the quality information provision unit displaying the indication without performing an authentication process on a user of the terminal. The user can therefore confirm the existence of information indicating deviation from the threshold without going through an authentication process. This can improve convenience for the user of the quality control information.

The present disclosure can improve the convenience for users of quality control information during quality control of products in the logistics industry.

### BRIEF DESCRIPTION OF THE DRAWINGS

In the accompanying drawings:

FIG. 1 is a block diagram illustrating the configuration of a quality control system according to an embodiment;

FIG. 2 illustrates an example of a distribution route;

FIG. 3 is a flowchart illustrating operations of a log sensor;

FIG. 4 is a flowchart illustrating operations of a sensor communication device;

FIG. 5 is a flowchart illustrating operations of a quality control server;

FIG. 6 illustrates an example of an initial settings screen;

FIG. 7 illustrates an example of a quality information provision unit;

FIG. 8 illustrates an example of an analysis display screen;

FIG. 9A illustrates an example of a summary screen for quality control information display;

FIG. 9B illustrates an example of a summary screen for quality control information display;

FIG. 9C illustrates an example of a summary screen for quality control information display;

FIG. 10 is a flowchart illustrating a quality deviation response process;

FIG. 11 illustrates an example of a report e-mailed to a notification recipient;

FIG. 12 illustrates an example of a report e-mailed to a party charged with prescribing countermeasures;

FIG. 13A illustrates an example of an e-mail related to an instruction to take a countermeasure;

FIG. 13B illustrates an example of an e-mail related to an instruction to take a countermeasure;

FIG. 13C illustrates an example of an e-mail related to an instruction to take a countermeasure;

FIG. 14A illustrates an example of a summary screen provided to the recipient; and

FIG. 14B illustrates an example of a summary screen provided to the recipient.

### DETAILED DESCRIPTION

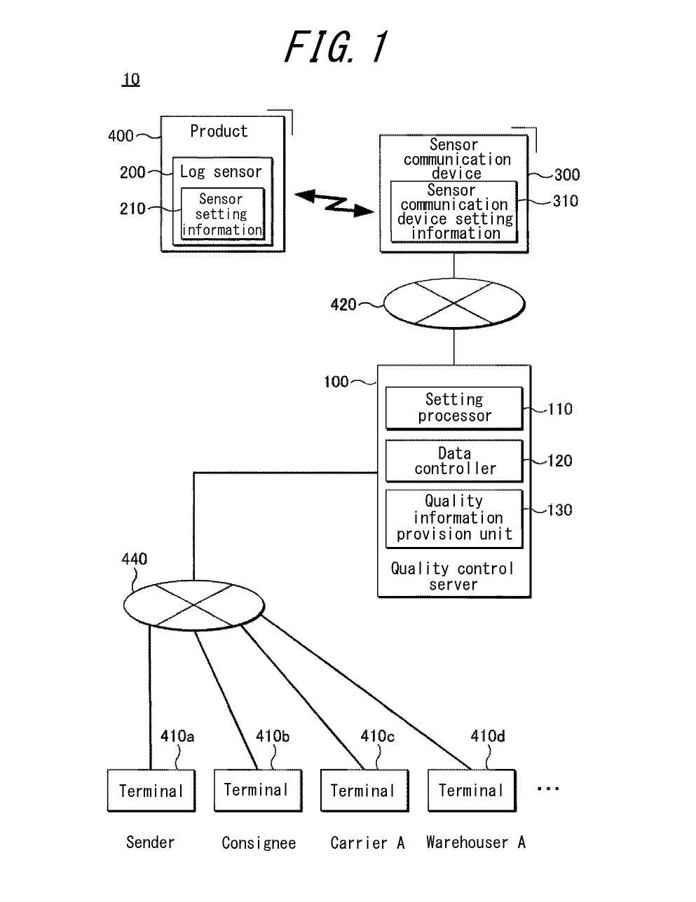

Embodiments of the present disclosure are described with reference to the drawings. FIG. 1 is a block diagram illustrating the configuration of a quality control system 10 according to an embodiment. A quality control server 100 in FIG. 1 is a server that performs quality control of a product 400 and provides quality control information.

The product 400 may, for example, be a food product, medical product, or the like for which quality control is required throughout the entire distribution route. The product 400 is assumed to be an individual product, a box including an individual product, or the like. The product 400 preferably has a log sensor 200 attached thereto. The log sensor 200 is therefore preferably thin and splash-proof. The sender, for example, may attach the log sensor 200 to the product 400. When the log sensor 200 is not attached directly to the product 400, then the log sensor 200 may, for example, be a USB or card-type temperature logger.

The log sensor 200 periodically measures the temperature, humidity, lighting intensity, acceleration, inclination, or the like and records the measured value as measurement data in an internal storage area. In the present embodiment, an example of the target of measurement being temperature is mainly described for the sake of convenience. The log sensor 200 has a unique identifier. The log sensor 200 can record sensor setting information 210 related to the measurement cycle and the like. The unique identifier of the log sensor 200 may be a 2D code, an RFID, or the like displayed on a surface.

A sensor communication device 300 communicates wirelessly with the log sensor 200 to collect the measurement data stored in the log sensor 200. General purpose techniques, such as RFID or Bluetooth® (Bluetooth is a registered trademark in Japan, other countries, or both), may be used for the wireless communication with the log sensor 200, and automatic reception without human operation is preferred.

The sensor communication device 300 can transmit the measurement data collected from the log sensor 200 to the quality control server 100 over a network 420. A mobile phone communication network or the Internet, for example, may be used as the network 420.

The sensor communication device 300 can be configured by a tag reader/writer, a communication terminal provided with a tag reader/writer function, or the like and is preferably small and battery-operated to allow permanent installation onto a pallet, a deck, or the like. The sensor communication device 300 is capable of recording sensor communication device setting information 310 related to collection of measurement data from the log sensor 200, transmission of the measurement data to the quality control server 100, and the like. When the sensor communication device 300 is permanently installed, an environment control function may be added to the sensor communication device 300 to allow control of the environment around the pallet, deck, or the like by an air conditioner, for example, on the basis of an instruction from the sensor communication device 300. When a control function is installed in the sensor communication device 300 in advance, the sensor communication device 300 may control the temperature or humidity, for example, to stay within a range allowing maintenance of quality to achieve transportation in an environment optimal for the characteristics of the products.

The sensor communication device 300 is configured to receive operations from an operator via a button or the like. The operations are an activation operation to start acquiring measurement data from the log sensor 200 and an operation to stop acquiring measurement data.

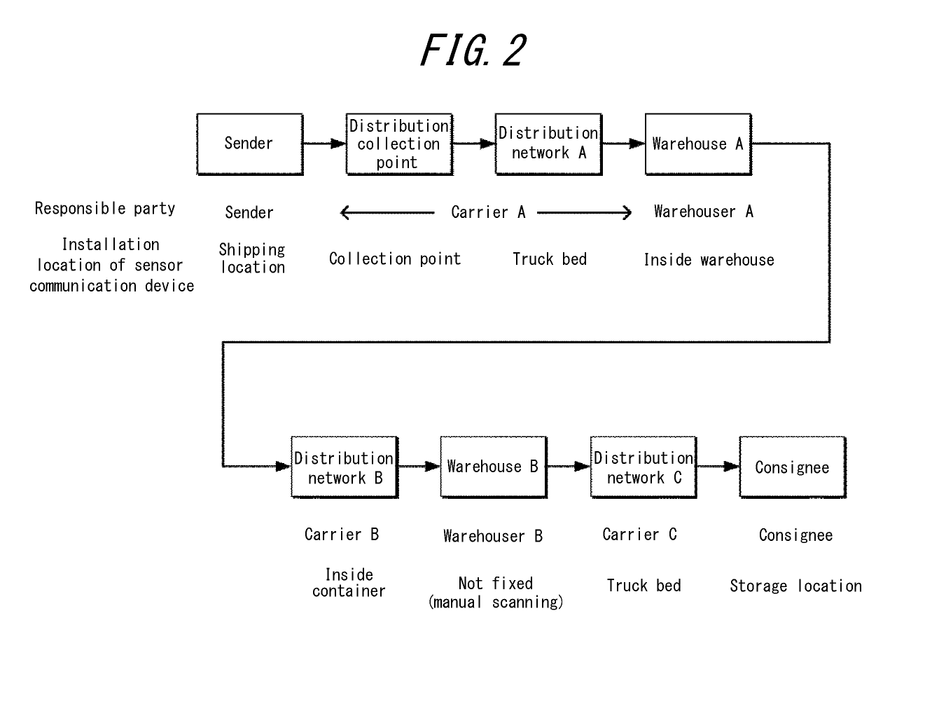

A plurality of sensor communication devices 300 are provided along the distribution route of the product 400, each device having a unique identifier. For example, when the product 400 follows the distribution route in FIG. 2 of “sender”→“distribution collection point” “distribution network A”→“warehouse A”→“distribution network B” “warehouse B”→“distribution network C”→“consignee”, a sensor communication device 300 can be permanently installed at the shipping location of the “sender” and on the truck bed used in the “distribution network A”. The sensor communication device 300 can also be permanently installed in a container, pallet, or the like. When the sensor communication device 300 cannot be permanently installed, the log sensor 200 may be manually scanned, as indicated for “warehouse B”. The location of the sensor communication device 300 that transmitted the measurement data can be understood by referring to the identifier of the sensor communication device 300.

Responsible parties are determined along each distribution route. For example, the responsible party for the “distribution collection point” and the “distribution network A” is carrier A, and the responsible party for the “warehouse A” is warehouser A. Installation and manual scanning of the sensor communication device 300 are, for example, performed by the responsible party for the installation location and scanning location.

Returning to FIG. 1, the quality control server 100 is connected to a plurality of terminals 410 (410a, 410b, 410c, 410d, . . . ) over a computer network 440. The terminal 410 is a device used by the sender, the consignee, the carrier A, the warehouser A, or the like. A PC, tablet, smartphone, or the like with a browser function may be used as the terminal 410. The computer network 440 can, for example, be the Internet.

The quality control server 100 can, for example, be configured using an information processing device such as a general purpose server computer. The quality control server 100 can also be configured in a cloud environment. The information processing device can function as the quality control server 100 by executing a computer program for controlling the below-described processes.

The quality control server 100 includes a setting processor 110, a data controller 120, and a quality information provision unit 130. The setting processor 110 receives initial settings via a webpage and sets the sensor communication device 300 and log sensor 200 on the basis of the initial settings. Information on settings related to thresholds of measurement data, the recipient of notification in the case of deviation from the threshold, the countermeasure to take in the case of deviation from the threshold, and the like is included in the initial settings.

The data controller 120 records and controls the measurement data received from the sensor communication device 300. The identifier and responsible party of each sensor communication device 300 are recorded in association in the data controller 120. The data controller 120 also controls the status of each log sensor 200 (active state/non-active state or the like).

The quality information provision unit 130 provides quality information of the product 400 via a webpage. Specifically, on the basis of a plurality of received sets of measurement data, the quality information provision unit 130 associates the change in temperature of the product 400 over time along the distribution route with information related to the responsible parties, location information, and the like and displays the result on the terminal 410 connected over the computer network 440. The quality information provision unit 130 can therefore perform quality analysis on the basis of the quality information and display the result along with appropriate advice.

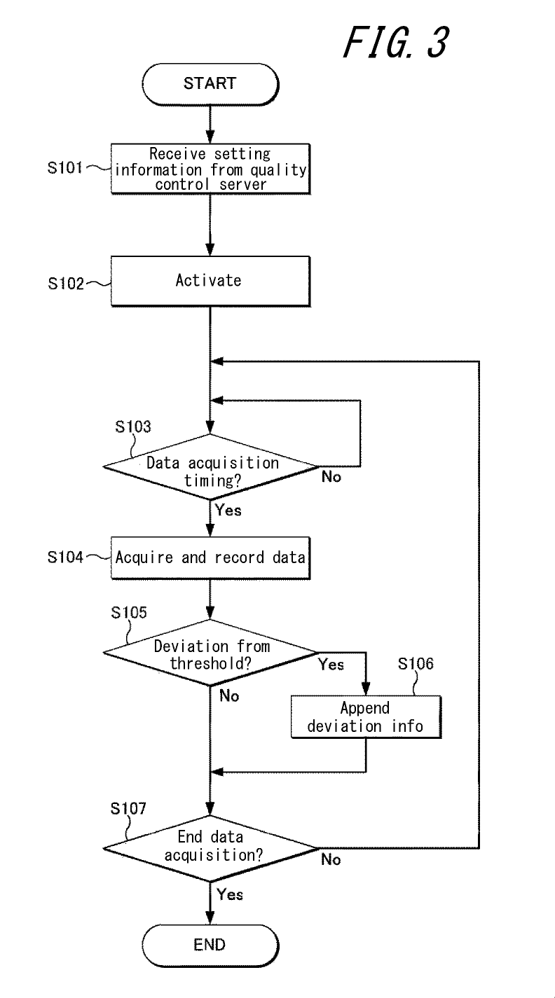

Next, operations of the quality control system 10 with the aforementioned configuration are described. First, operations of the log sensor 200 are described with reference to the flowchart in FIG. 3. Each type of log sensor 200 measures one or more of the following physical quantities that affect the quality of the product 400: temperature, humidity, lighting intensity, acceleration, inclination, and the like. The appropriate type of log sensor 200 is selected in accordance with the product 400 that includes the target of attachment. Here, it is assumed that a type of log sensor 200 including temperature as the target of measurement is selected.

First, the log sensor 200 receives settings from the quality control server 100 (S101). The log sensor 200 may also receive settings indirectly from the quality control server 100 through the sensor communication device 300.

The settings received by the log sensor 200 include the cycle for acquiring measurement data and the threshold. The cycle for acquiring measurement data can, for example, be every X minutes. The threshold is a set value prescribing the measurement data range over which the product 400 to which the log sensor 200 is to be attached can be considered normal. The threshold may, for example, be from A to B degrees Celsius. The threshold may instead be constituted by only an upper or lower limit.

Having received the settings, the log sensor 200 is attached to the product 400 by the sender or the like and is activated by the sensor communication device 300 provided at the sender's location (S102). Upon activation, periodic acquisition of measurement data in accordance with the settings begins.

When the data acquisition timing is reached (S103: Yes), the log sensor 200 acquires measurement data, appends time information, and records the result in an internal storage area as measurement data (S104). The log sensor 200 does not execute step S104 if the data acquisition timing has not been reached (S103: No).

When the acquired measurement data deviates from the set threshold (S105: Yes), the log sensor 200 appends deviation information to the measurement data (S106). When a push function is provided in the log sensor 200 and threshold deviation is detected, a push notification may be provided immediately to the sensor communication device 300. When the acquired measurement data does not deviate from the set threshold (S105: No), the log sensor 200 transitions to step S107.

The log sensor 200 repeats the above-described measurement data acquisition process until receiving an instruction to end data acquisition from the sensor communication device 300. In other words, the log sensor 200 transitions to step S103 when an instruction to end data acquisition has not been received (S107: No). Conversely, when an instruction to end data acquisition has been received (S107: Yes), the log sensor 200 ends the measurement data acquisition process.

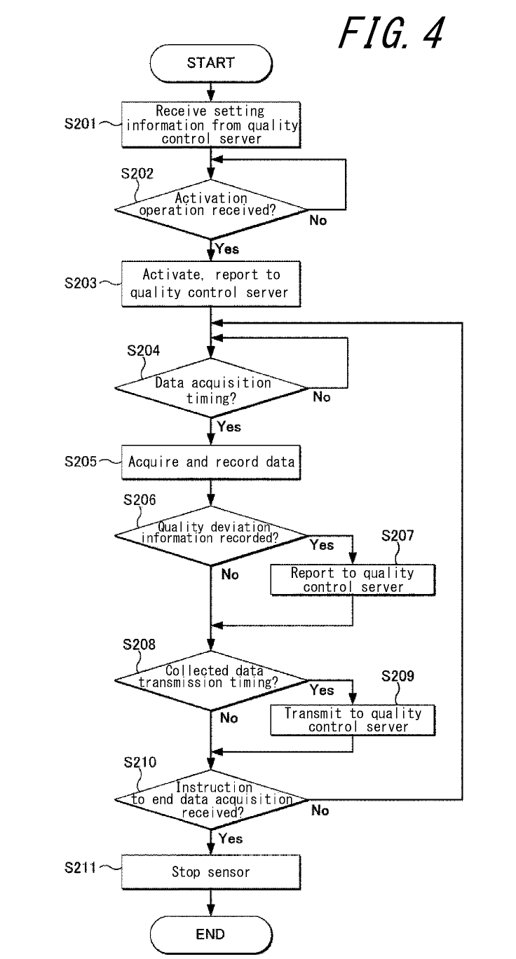

Next, operations of the sensor communication device 300 are described with reference to the flowchart in FIG. 4. The sensor communication device 300 is permanently installed, for example, by each responsible party or the like. The identifier of each sensor communication device 300 is recorded in the data controller 120 of the quality control server 100 in association with the responsible party.

The sensor communication device 300 receives settings from the quality control server 100 (S201). The settings received by the sensor communication device 300 include the cycle for collecting measurement data from the log sensor 200 and the cycle for transmitting the collected measurement data to the quality control server 100.

When the sensor communication device 300 that is installed at the sender's location and is capable of communicating with the log sensor 200 attached to the product 400 receives an activation operation from the sender, the carrier, or the like (S202: Yes), the sensor communication device 300 activates the log sensor 200 (S203). As a result, the log sensor 200 starts the measurement data acquisition process. Conversely, the sensor communication device 300 does not execute step S203 if an activation operation has not been received (S202: No).

The sensor communication device 300 also notifies the quality control server 100 of activation of the log sensor 200 (S203). The content of the notification may, for example, be the identifier of the activated log sensor 200 or the status (active state) of the log sensor 200.

Subsequently, collection and transmission of measurement data in accordance with the settings begins. In other words, when the data collection timing is reached (S204: Yes), the sensor communication device 300 communicates with the log sensor 200 to collect time series measurement data and record the data in an internal storage area (S205). The sensor communication device 300 may be configured to delete collected time series measurement data from the storage area of the log sensor 200 at this time. The sensor communication device 300 does not execute step S205 if the data acquisition timing has not been reached (S204: No).

When communicating with the log sensor 200, the sensor communication device 300 may perform actions such as charging the log sensor 200 by radio transmission or the like and adjusting the data measurement cycle in accordance with the environment or the like. The data measurement cycle may be adjusted manually by operation of the sensor communication device 300 or automatically in accordance with a predetermined rule. The rule can, for example, associate the measurement cycle with a time, place, or the like, or be based on a transportation schedule.

For example, the setting may reduce the frequency of reception in the case of a large number of days for transportation, such as on a ship, or in accordance with an environment not conducive to data collection by the sensor communication device 300, such as on an airplane with restricted communication. In these cases, the setting may indicate storage of the time series measurement data on the log sensor 200. The log sensor 200 may also be provided with a GPS function, and the measurement cycle may be varied in accordance with displacement. The measurement cycle can thus be adapted to the environment, and memory and battery use can be optimized.

In the case of manual scanning, the operator collects and records time series measurement data when performing a scan manually.

When no deviation information is recorded in the collected time series measurement data (S206: No), then upon reaching the data transmission timing (S208: Yes), the sensor communication device 300 transmits the recorded time series measurement data to the quality control server 100 (S209).

Conversely, when deviation information is recorded in the collected time series measurement data (S206: Yes), the sensor communication device 300 can notify the quality control server 100 immediately, regardless of the set transmission cycle (S207).

Furthermore, when no deviation information is recorded in the collected time series measurement data (S206: No), and the data transmission timing has not been reached (S208: No), the sensor communication device 300 transitions to step S210 without notifying or transmitting data to the quality control server 100.

The sensor communication device 300 repeats the above-described measurement data acquisition process until receiving an instruction to end data acquisition. In other words, the sensor communication device 300 transitions to step S204 when an instruction to end data acquisition has not been received (S210: No). Conversely, when an instruction to end data acquisition has been received (S210: Yes), the sensor communication device 300 instructs the log sensor 200 with which the sensor communication device 300 can communicate to end data acquisition (S211).

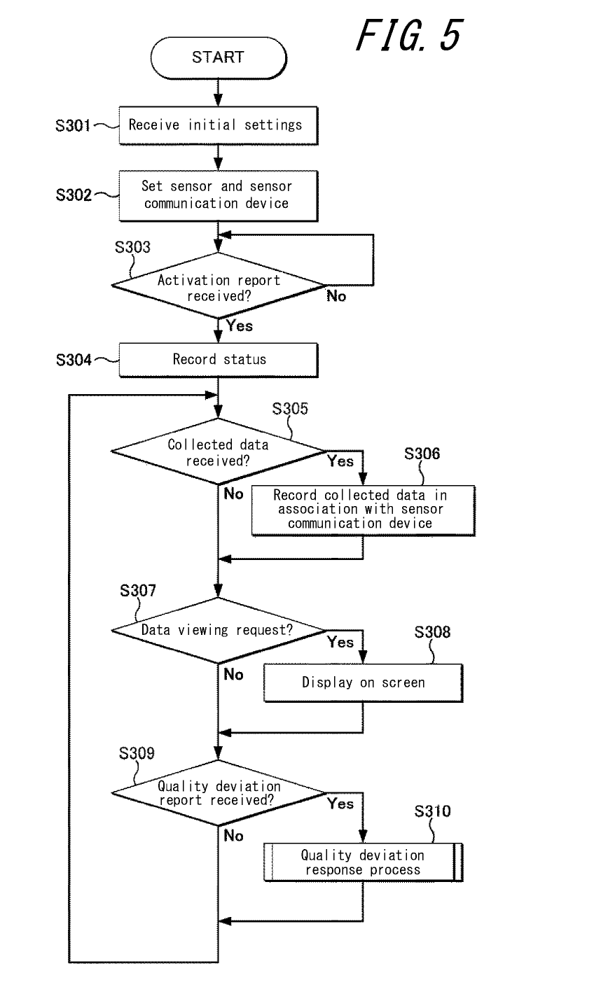

Next, operations of the quality control server 100 are described with reference to the flowchart in FIG. 5. First, the setting processor 110 of the quality control server 100 receives initial settings from the user (S301). The user may, for example, be the sender of the product 400 or the consignee. The administrator of the quality control server 100, the carrier, or the like may perform the initial settings instead of the user.

Before the initial settings, it is assumed that the user has signed a service contract or the like with the administrator of the quality control server 100, and that a login ID, the URL of a webpage for initial settings, the URL of a webpage for viewing quality control information, and the like have been determined. By accessing these URLs with the terminal 410, the user can set the password, perform initial settings, view the quality control information, and the like.

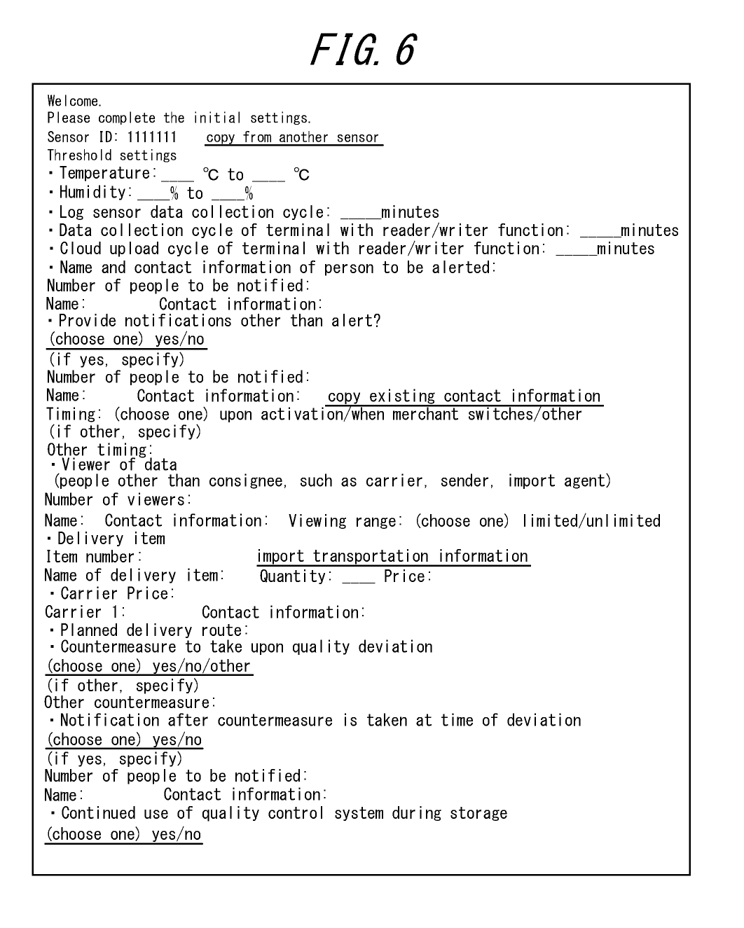

The initial settings can, for example, be performed on a screen such as the one in FIG. 6. The settings for the log sensor 200, for example, may be a threshold and a data acquisition cycle. The settings for the sensor communication device 300, for example, may be the cycle for collecting the measurement data from the log sensor 200 and the cycle for transmitting the collected measurement data to the quality control server 100.

The settings for operations of the quality control server 100 may be information related to a product, the planned delivery route, the name and contact information of the person to be alerted when quality deviation occurs, whether notifications other than the alert are provided, people other than the consignee who view data, the countermeasure to take upon quality deviation, whether use of the quality control system continues during storage, and the like.

The method of contacting the person to be alerted may, for example, be e-mail, a short message service (SMS) message, or a social networking service (SNS) message. Notifications other than alerts may, for example, be an activation report or a report at each arrival point.

The people other than the consignee who view data can be the sender, the carrier, the warehouser, an import agent, or the like. Allowing a person set by the user to view a designated range of data makes it possible to control the dissemination of information for the packages. Related merchants can also be allowed to view data only within their own area of responsibility. A person who views data is notified of the URL of a webpage for viewing quality control information. Continued use of the quality control system during storage is described below.

Upon receiving the initial settings from the user, the setting processor 110 of the quality control server 100 sets the log sensor 200 and the sensor communication device 300 in accordance with the received settings (S302). Specifically, for the log sensor 200, the setting processor 110 sets the threshold and the data acquisition cycle, and for the sensor communication device 300, the setting processor 110 sets the cycle for collecting the measurement data from the log sensor 200 and the cycle for transmitting the collected measurement data to the quality control server 100.

Subsequently, when a report that the log sensor 200 has been activated is received from the sensor communication device 300 (S303: Yes), the data controller 120 of the quality control server 100 records the status of the log sensor 200 (S304). The data controller 120 also notifies the user designated by the initial settings as requiring an activation report. The data controller 120 does not execute step S304 if the report of activation of the log sensor 200 has not been received (S303: No).

Thereafter, when measurement data is received from a sensor communication device 300 (S305: Yes), the data controller 120 of the quality control server 100 associates the measurement data with the sensor communication device 300 and records the measurement data (S306). The quality control server 100 can thus learn the environmental conditions of the product 400 to which the log sensor 200 is attached, such as temperature, humidity, and lighting intensity; the location of the product 400 along the distribution route; and the like. When measurement data has not been received from a sensor communication device 300 (S305: No) the data controller 120 transitions to step S307.

When a data viewing request is received from the terminal 410 of a person allowed to view data (S307: Yes), the quality information provision unit 130 of the quality control server 100 displays a screen for providing quality control information on the terminal 410 (S308). After activation of the log sensor 200, people allowed to view data can view quality control information from their own the terminal 410 at any time during transportation of the product 400. When a data viewing request has not been received from the terminal 410 of a person allowed to view data (S307: No), the quality information provision unit 130 transitions to step S309.

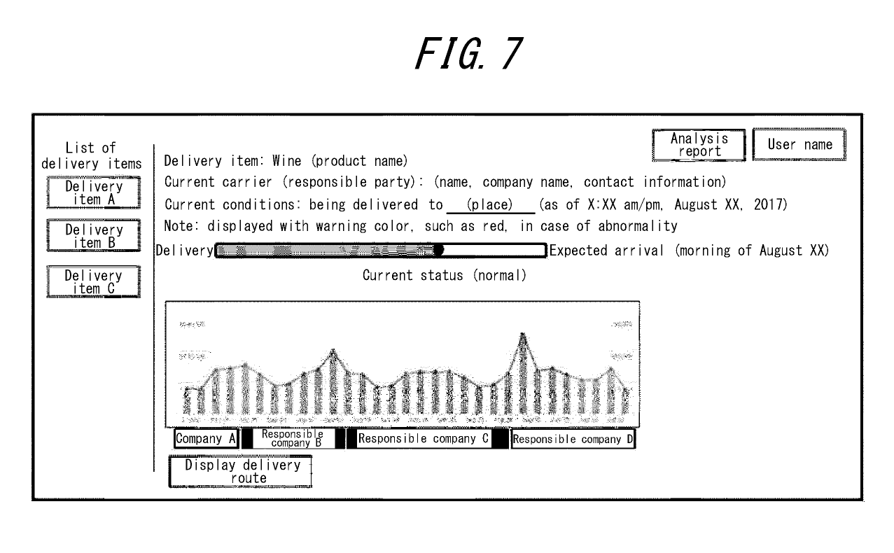

FIG. 7 illustrates an example of a quality information provision unit. This example displays the name of the product, the current conditions, and the like, along with a graph of the temperature history up to the present. The viewer can thus confirm the current location, status, and the like of the product 400. This information can be displayed for each product 400 to be delivered.

Furthermore, information indicating the responsible party during each period, such as “responsible company B” and “responsible company C”, is indicated in the graph along the changes in temperature over time that are based on the measurement data received from each sensor communication device 300. The viewer can thus easily learn who is responsible, for example, when the temperature deviates from the threshold, thereby allowing the viewer to immediately contact the responsible party for the location where the temperature deviated from the threshold.

Since the information indicating the responsible party is recorded in association with the sensor communication device 300 in the data controller 120, the quality information provision unit 130 can append the information indicating the responsible party by referring to the recorded information. In cases such as deviation of the temperature from the threshold, the quality information provision unit 130 may display the corresponding portion of the graph with emphasis.

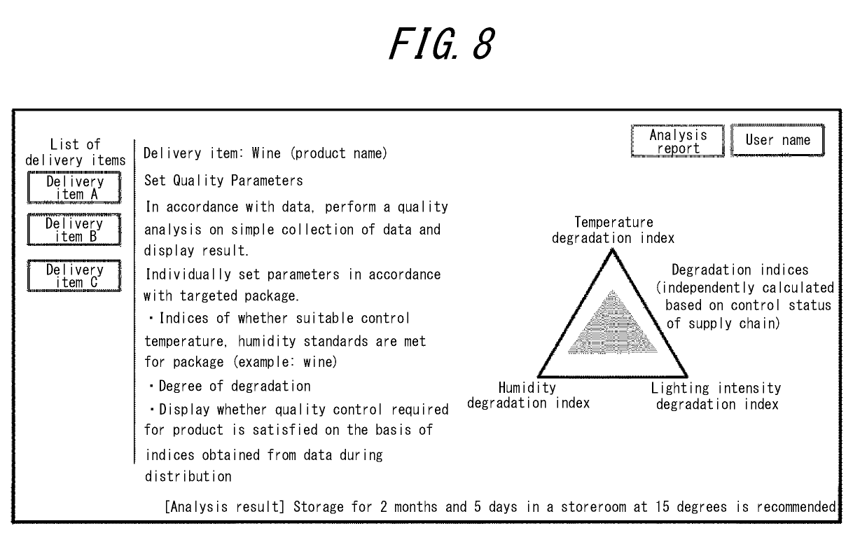

When the log sensor 200 measures temperature, humidity, and lighting intensity, for example, then the quality information provision unit 130 may determine a rule for calculating a degradation index on the basis of the temperature history, humidity history, and lighting intensity history and may indicate the optimal control method for each product 400 using machine learning or artificial intelligence (AI) on the basis of the temperature degradation index, humidity degradation index, and lighting intensity degradation index and the characteristics of the item being transported. The quality information provision unit 130 may also indicate the optimal time for consumption when the item being transported is a food product. The quality information provision unit 130 may provide the person allowed to view data with an analysis display screen displaying the degradation indices and the like, as in FIG. 8. In accordance with the type of parameters measurable by the log sensor 200, the quality information provision unit 130 may select and change the degradation indices to display and may increase or decrease the number of degradation indices to display.

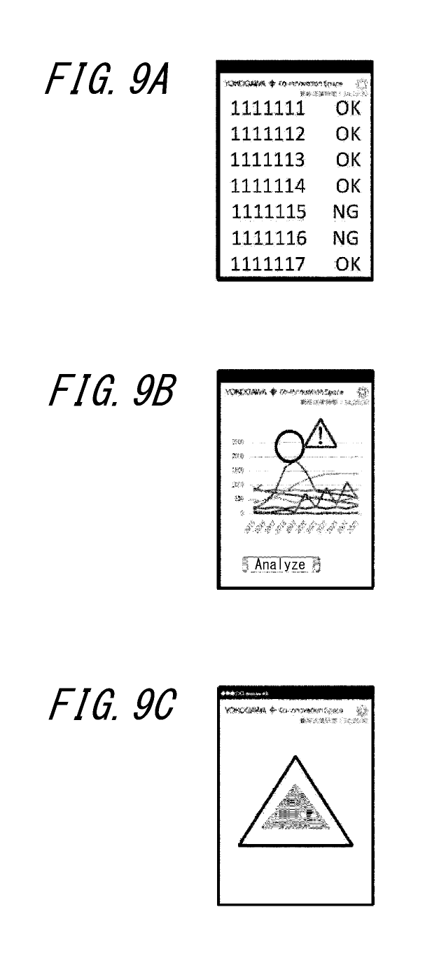

When the terminal 410 used by the person viewing data is a smartphone or the like and the display screen area is limited, then a summary screen as in FIGS. 9A, 9B, and 9C may be displayed. In the present example, the screen in FIG. 9A designates the log sensor 200 to be viewed, the screen in FIG. 9B displays the temperature history, and the screen in FIG. 9C displays the degradation indices.

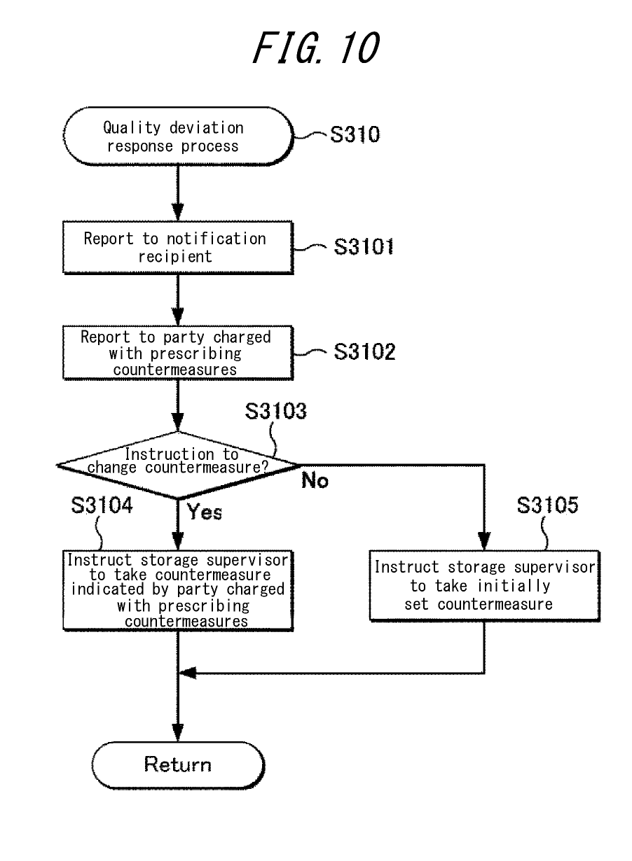

When the quality control server 100 has received a quality deviation report from the sensor communication device 300 (S309: Yes), the quality control server 100 performs a quality deviation response process (S310). When measurement data has not been received from a sensor communication device 300 (S309: No) the quality control server 100 transitions to step S305. Next, the quality deviation response process of step S310 is described with reference to the flowchart in FIG. 10.

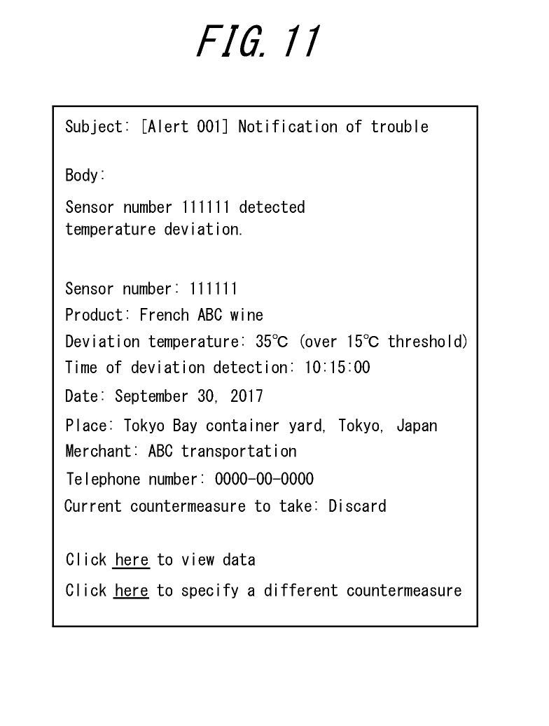

When starting the quality deviation response process (S310), the quality control server 100 sends a report to the notification recipient set by the initial settings (S3101). FIG. 11 illustrates an example of a report e-mailed to a notification recipient. The report can, for example, describe the deviation and indicate the time and place where the deviation occurred. The occurrence of quality deviation is also displayed on the quality information provision unit.

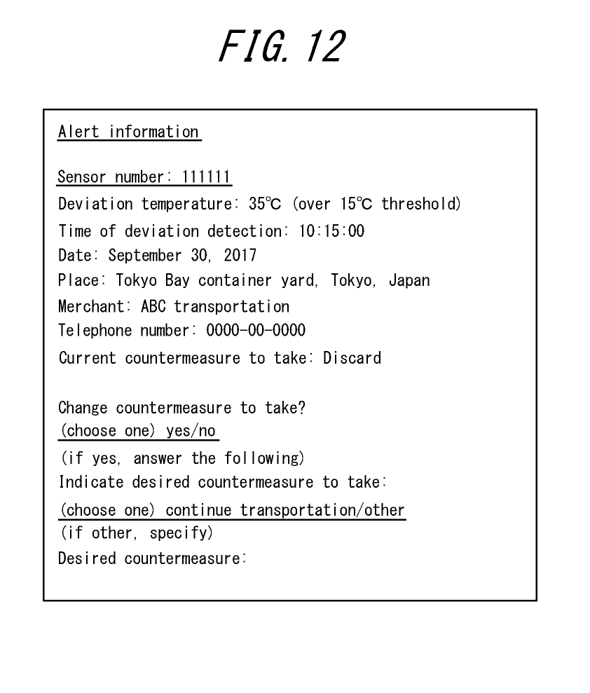

The quality control server 100 also sends a report to the party, set by the initial settings, charged with prescribing countermeasures (S3102). FIG. 12 illustrates an example of a report e-mailed to a party charged with prescribing countermeasures. For example, in addition to describing the deviation and indicating the time and place where the deviation occurred, the report can inquire whether to change the countermeasure to take as set by the initial settings, what the desired countermeasure is in the case of changing the countermeasure, and the like. The recipient can respond to the inquiry on a webpage linked to by the e-mail, for example.

When, in response to the report, the quality control server 100 receives an instruction to change the countermeasure to take from the party charged with prescribing countermeasures (S3103: Yes), the quality control server 100 transmits an e-mail or the like to the responsible party storing the product 400 at that point with an instruction to take the countermeasure desired by the party charged with prescribing countermeasures (S3104).

On the other hand, when no change in the countermeasure is indicated by the party charged with prescribing countermeasures (S3103: No), i.e. when the received response to the report indicates no need for a change in the countermeasure, or when no response to the report is received from the party charged with prescribing countermeasures within a predetermined time period, the quality control server 100 transmits an e-mail or the like to the responsible party storing the product 400 at that point with an instruction to take the countermeasure set by the initial settings (S3105).

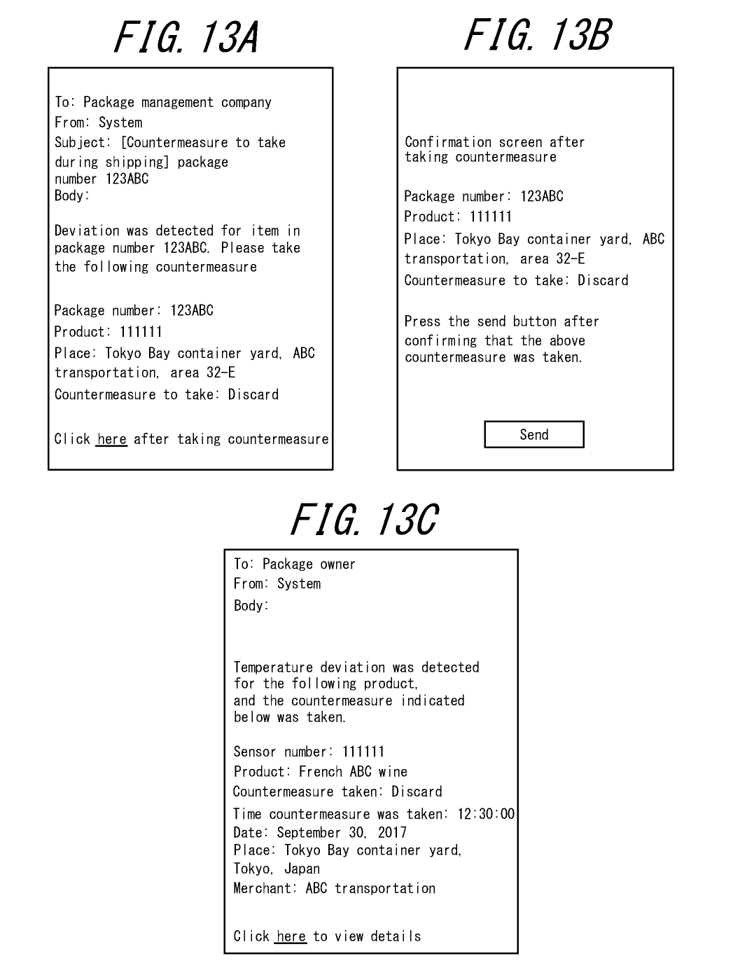

FIGS. 13A and 13B are examples of e-mails sent to the responsible party. FIG. 13A illustrates the content of an instruction to take a countermeasure, and FIG. 13B illustrates the content of a report that the countermeasure was taken. When the report that the countermeasure has been taken is received from the responsible party, an e-mail such as the example in FIG. 13C is sent to the party charged with prescribing countermeasures.

Next, use of the quality control system during subsequent storage of a product, i.e. continued use of the quality control system after delivery, is described. The quality control system 10 can continue to collect and control data even when products are being stored after transportation. In this case, the quality control system 10 continues to collect measurement data after a product has reached its destination, i.e. the consignee. In other words, the quality control system 10 does not turn the log sensor 200 off.

For continued use, the user installs a sensor communication device 300 in the location for storing the delivered product 400 in an appropriate environment. A sensor communication device 300 installed in the past can also be used.

The user logs into the quality control server 100 and indicates a desire for continued use. The user can also make this selection during the initial settings. When the settings in the storage environment have changed from the time of initial settings, the user makes corresponding changes. The user performs a process on the quality control server 100 to recognize the storage supervisor as a new user when the storage supervisor differs from the user. The storage supervisor can thus use the quality control server 100 as a new user. The settings and operations of the quality control server 100 are similar to those described above.

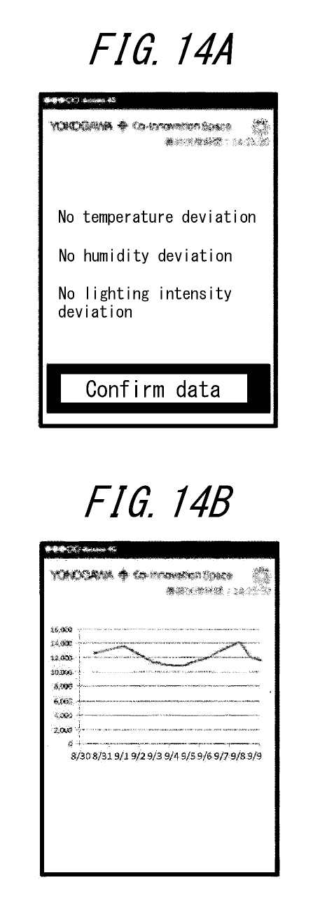

The recipient of the product 400, such as the buyer, can confirm how the product 400 was controlled until reaching the recipient. For example, the recipient can confirm that deviation or the like did not occur on a summary screen such as the ones illustrated in FIGS. 14A and 14B. In this case, the recipient can confirm that temperature deviation did not occur, confirm the temperature history, and the like by using the terminal 410, which is a smartphone or other device, to scan a 2D code or the like displayed on the log sensor 200 attached to the product 400 and to access the URL indicated by the 2D code or the like. This screen is displayed on the terminal 410 of the recipient without the need for a user ID or password authentication.

The quality control information provided by the quality control server 100 can also be associated with manufacturing information. Associating the quality control information and the manufacturing information allows integral control of the time and conditions of manufacturing and the shipping time for products requiring a high guarantee of security, such as medical products.

Associating the quality control information and the manufacturing information allows an appropriate response in the event a recall or the like becomes necessary.

It also becomes possible to issue a report responding to an audit requested for medical products or the like. Document collection for audits thus becomes unnecessary, and reports can automatically be organized for each product chronologically.

Other example applications include removing personal information from the data and providing the data for a fee to an uninvolved distributer or insurance provider. For example, a distributor may be provided with data for making improvements based on trends in the collected data. Suggestions for improvement can also be made by providing the distributor with the analyzed data.

New services related to insurance and securities for distribution can also be created for insurance providers by utilizing the data collected with the same system.

Furthermore, a service may be offered to certify the quality, to the manufacturer, of products for which the quality control server 100 was used. A certification logo can be attached to the products that have been certified for greater customer appeal, and a service can be offered to guarantee suspension of delivery and redelivery in the case of deviation from the threshold.

1. A quality control server comprising:
a data controller configured to:
receive measurement data acquired by a sensor attached to a product, the measurement data being received through a plurality of sensor communication devices installed at a plurality of predetermined installation locations along a distribution route of the product, each sensor communication device being associated with information indicating a responsible party for the predetermined installation location of the sensor communication device; and
record the measurement data; and
a quality information provision unit configured to:
associate a plurality of received measurement data from the plurality of predetermined installation locations with the information indicating the responsible party for the predetermined installation location on the basis of the plurality of received measurement data, location information indicating locations where the plurality of sensor communication devices are installed, and the distribution route;
associate the measurement data with the location information; and
display the measurement data and the location information on a terminal connected over a network.

2. The quality control server of claim 1, wherein
the sensor comprises a setting processor configured to perform a setting related to a threshold of the measurement data; and
the data controller is configured to alert a predetermined recipient when information indicating deviation from the threshold is included in the received measurement data.

3. The quality control server of claim 2, wherein
the data controller is configured to issue an inquiry related to a countermeasure to be taken to a predetermined party charged with prescribing countermeasures when the information indicating deviation from the threshold is included in the received measurement data; and
the data controller is configured to notify the responsible party, associated with the sensor communication device that transmitted the information indicating deviation from the threshold, of an instruction based on a response to the inquiry.

4. The quality control server of claim 2, wherein the quality information provision unit is configured to display an indication of whether the information indicating deviation from the threshold exists for the product on the terminal connected over the network, the quality information provision unit displaying the indication without performing an authentication process on a user of the terminal.
